(19) United States
(12) Patent Application Publication
(10) Pub. No.: US 2011/0045238 A1
(43) Pub. Date: Feb. 24, 2011

(54) Printing Template of an SMT Process and Method of Coating It

(76) Inventors: Heinrich Zeininger, Obermichelbach (DE); Rudolf Zrenner, Amberg (DE)

Correspondence Address: King & Spalding LLP, 401 Congress Avenue, Suite 3200, Austin, TX, 78701, US

(21) Appl. No.: 12/067,560

(22) PCT Filed: Aug. 25, 2006
(86) PCT No.: PCT/EP06/65666

§ 371 Date: Jul. 21, 2008

(30) Foreign Application Priority Data
Sep. 22, 2005 (DE) 10 2005 045 350.3

(51) Int. Cl. B32B 3/10; B05D 1/18; B05D 1/02; H05H 1/02; B29C 65/48

(52) U.S. Cl. 428/137; 427/430.1; 427/421.1; 427/570; 156/289

(57) ABSTRACT

The printing template (2) of an SMT process includes a metallic template body (2a) with clearances (3) corresponding to a desired printing structure. A printing material is to be applied through these clearances (3) to a plate that is to be joined onto the printing template from below. To prevent the printing material from adhering in the region of the clearances (3), the metallic template body (2a) is to be provided with a thin coating (6) of a metal-alkoxide coating material, the surface energy of which is reduced by chemical bonding of at least one organic component. The coating may be performed in particular by means of a sol-gel process.

The invention relates to a printing template of an SMT process, which in its metallic template body comprises clearances corresponding to a predetermined printing structure through which a printing material is to be applied to a plate that is to be joined onto the printing template from below. A corresponding metallic template is known, e.g. from DE 44 38 281 C1. The invention also relates to methods for coating printing templates of this kind.

Corresponding printing templates are preferably used for SMT (surface mounted technology) processes in which printed circuit boards are to be fitted with electronic components. For this, the printed circuit boards are first provided at specific points with a printing or solder paste or with an adhesive according to a predetermined printing structure by means of screen printing technology. Hereby, the solder paste or the adhesive paste is applied to the printed circuit board in question by means of a so-called doctor knife through clearances of a metallic template body corresponding to the printing structure. This results in solder paste depots or adhesive points, so-called pads, to which the electronic components are applied and then fixed e.g. by means of a component insertion machine.

A corresponding printing template, known as a screen printing screen, and a method for its production are known from DE 44 38 281 C1 mentioned in the introduction. Hereby, the effective screen printing screen substantially comprises a dimensionally stable frame to which a fine metal wire woven fabric is glued under pretension. Attached in a central region of this metal wire fabric is a thin-walled metallic template comprising the printing pattern formed by the clearances.

The production of a metallic printing template of this kind is also described in U.S. Pat. No. 2,421,607 A.

The advancing miniaturization of electronic components is also being accompanied by a corresponding reduction of the clearances in the printing templates. This gives rise to the risk of solder or adhesive points or paste depots adhering to the edges or walls of apertures determined by the printing pattern in question of the metal used as template material so that the corresponding clearances are able to increment successively. This in turn frequently results in the pulling-out or tearing of the outer edges of the pads applied to the printed circuit board when the printing template is raised. This means that the requirements relating to a desired sharp-contoured printed image on the printed circuit board can no longer be fulfilled.

Due to this risk, it is frequently necessarily to improve the printing quality by means of special cleaning cycles. However, cleaning means an interruption to the process and hence a negative influence on the productivity in the process. A further possibility for error reduction is seen in the improvement of the metallic printing template by electropolishing in the region of its clearances. This results in a corresponding increase in the price of the production of the templates. There have also been attempts to circumvent said problems by a different choice of template material such as glass [see e.g. DE 101 05 329 A1]. However, this material only permits comparatively large clearances.

The invention is therefore based on the object of providing a printing template suitable for SMT processes such as e.g. for printed circuit board assembly or module production with which the described risk of the increment or contamination of the clearances is at least reduced.

This object is achieved by means of the measures specified in claim 1. According to this, the printing template with the features mentioned in the introduction should be designed so that its metallic template body is provided with a thin coating of a metal-alkoxide coating material, the surface energy of which is reduced by chemical bonding of at least one organic component.

It has been found that, with metallic template bodies, the use of pure metal-oxide materials for the coating achieves little success only. It has now been recognized that the selective chemical bonding of organic components (groups or molecular chains) to a metal-alkoxide material, i.e. with organoalkoxide compounds, makes it possible to achieve a clear reduction in the surface energy (compared to the unmodified metal-oxide coating material). The consequence of this is a corresponding reduction in the adhesion of the generally paste-like solder or adhesive material to be applied via the clearances of the printing template onto underlying printed circuit boards to the template body, in particular to the walls of its clearances. The so-called release behavior in particular of the clearances of the metallic template bodies can therefore be improved during a printing process (application of the printing material) with the low-energy coating material. This is associated with the advantage that clearances with very small dimensions can be used without any risk of an increment.

A coating of this kind in the region of the template clearances combines two positive properties: the clearances retain their expansion because only thin layers, in particular in the nanometer range, are required. In addition, the walls of the clearances are virtually “smoothed” by the coating material, or, and this has the same positive effect, provided with a regular structuring.

Advantageous embodiments of the printing template according to the invention may be derived from the claims dependent upon claim 1.

For example, advantageously the metal-alkoxide coating material can at least comprise at least one alkoxide of one or more of the elements aluminum (Al), silicon (Si), tantalum (Ta), titanium (Ti), zirconium (Zr), hafnium (Hf) or yttrium (Y). With corresponding metal alkoxides, it is then possible to form particularly suitable, thermally stabile coating materials in the form of so-called hybrid polymers (with the alkoxide and an organic network).

The organic component in such hybrid polymers can hereby preferably be formed by an alkyl group or aryl group or a siloxane group. In addition, the particular choice of the coating material can prevent or at least greatly reduce the increment or addition of the clearances due to property of the layer material of repelling the paste-like material.

If a metal-alkoxide coating material is provided in which additionally a fluorine-containing component, e.g. in the form of a fluoroaryl group, is incorporated, this encourages the water-repellent and/or oil-repellent repellent property of the coating still further.

This repellent property is to be ensured in all cases when the printing template has a surface energy of the coating of less than 20 mN/m (milliNewtons per meter), preferably of less than 15 mN/m.

As a result of the coating according to the invention, it is advantageously possible for the maximum expansion of at least one of the clearances to be so small that it is between 200 μm and 500 μm.

Furthermore, advantageously the printing template can have a thickness of the coating of less than 10 μm, preferably less than 5 μm. Small thicknesses result in a corresponding reduction in the risk of the adhesion of paste-like printing material residue.

Preferably, the printing material to be applied can be a paste-like solder material or adhesive material.

Particularly advantageously, a coating of a printing template can be produced by means of a sol-gel process in which a preliminary material of the coating material is applied by wet chemical means to the metallic template body and then thermally cured. Hereby, the preliminary material can in particular be applied by spraying or immersion or flooding or rolling or painting.

A further advantageous method for coating a printing template is characterized in that a CVD (chemical vapor deposition) process with plasma assistance under low pressure or atmospheric pressure is used.

Both coating methods advantageously result in virtually non-adherent coatings in particular on the walls of the clearances. The incorporation of fluorine-containing components in the metal-alkoxide material can advantageously still further encourage the water-repellent and/or oil-repellent action.

For further explanation of the invention, the following refers to the drawings which illustrate a preferred exemplary embodiment. Here,

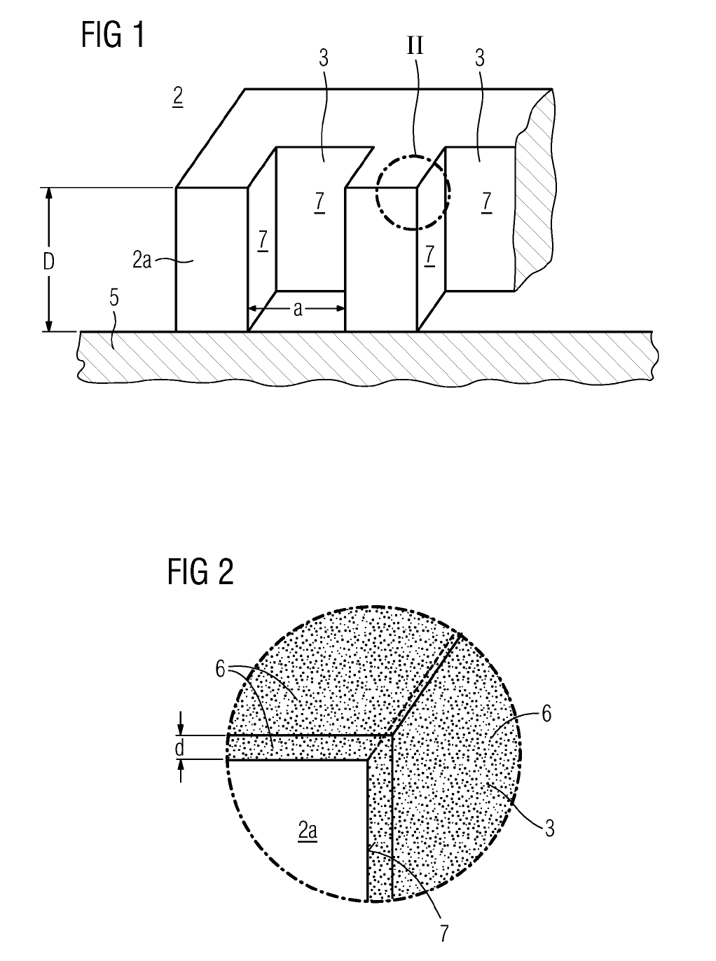

FIG. 1 is an extremely schematic, non-true-to-scale depiction of the construction of a coated printing template according to the invention, while

FIG. 2 shows an enlarged section from a region of this template. Corresponding parts are provided with the same reference numbers in the figures.

The printing template shown in the figures in sectional view and generally designated 2 is based on per se known embodiments of templates of this kind. Its metallic template body 2a preferably comprises a steel, such as in particular a high-grade steel, e.g. a CrNi steel, or Ni or another Ni alloy. Its thickness D is frequently between 100 and 5000 μm. Clearances 3 or other openings (apertures) are incorporated in the template body 2a in a known way, e.g. by means of laser technology or galvanoplastic methods. The maximum dimension a of these clearances is in general between 200 μm and 500 μm, for example approximately 400 μm. It depends upon the desired size of the pad comprising a known per se printing material, such as in particular a known soldering or adhesive paste, to be applied to an underlying printed circuit board 5 (bonding surface). For this, the printing template 2 is printed onto the printed circuit board 5. From the open side of the clearances 3, the soldering or adhesive paste is then introduced by means of a doctor knife moving along the free surface of the printing template.

So that after this printing process, when the printing template 2 is subsequently lifted from the printed circuit board 5, the solder or adhesive paste can be easily removed from the printing template, in particular from the walls of its clearances 3 (so-called release behavior), according to the invention, this is provided with a special functional coating. Here, it is assumed that the pull-off behavior on the walls 7 of clearances 3 of the template can be suppressed by coating the surfaces affected with a coating material, which will result in a reduction in the surface energy to less than 20 mN/m, preferably to less than 15 mN/m. Suitable coating materials for this are thermally stabile metal-alkoxide materials [see e.g. “Römpp Chemie Lexikon”, 9th Edition 1989, C. Thieme Verlag Stuttgart (DE), Page 115 or 106], which are chemically bonded with organic groups, so-called organometal alkoxide compounds. These materials can be produced for example by a sol-gel method or by a reactive plasma deposition process using low pressure or atmospheric pressure plasma.

The following will describe in more detail these two advantageous methods with which a coating according to the invention can be performed. Hereby, generally known details or steps of this method will not be described in further detail:

### I. Coatings Using the Sol-Gel Method

A coating designated generally with 6 in FIG. 2 with non-stick properties in particular with respect to the side walls 7 of the clearances 3 has a network-like structure with organic and inorganic components of the coating material. The preliminary or starting materials (so-called “precursors”) used to form corresponding coatings are metal alkoxides chemically modified with organic components or side chains. Particularly suitable are metal alkoxides of the elements Al, Si, Ta, Ti, Zr, Hf, Y. Selected as a corresponding, preferred exemplary embodiment is an Si alkoxide with the following structure:

Xn-Si—(OR)4−n.
Here:
X=an organic modification of the alkoxide,
R=an alkyl group such as a methyl or [ethyl] group, or an aryl group such as a phenyl group [see e.g. “Römpp Chemie Lexikon”, 9th Edition 1989, C. Thieme Verlag Stuttgart (DE), Page 115 or 260],
O=oxygen.
X can be a reactive or non-reactive side chain. The production of the coating is performed by hydrolysis and condensation of the modified metal alkoxides.
The organic modification of the metal alkoxide significantly influences the properties of the coating. For example, hydrophobic side chains X such as alkyl chains, aryl groups, fluoroalkyl chains or siloxane groups drastically reduce the surface energy of the coating and achieve a water-repellent (hydrophobic) and/or oil-repellent (oleophobic) effect.
Obviously, the aforementioned in particular hydrophobic sol-gel-based coating material can be further modified by the incorporation of surface-treated nanoscale or microscale particles, in order in this way for example to improve the mechanical abrasion resistance or corrosion resistance or to obtain particular catalytic effects. For example, the incorporation of catalytically active components, e.g. in the form of nanoscale or microscale catalyst particles, can thermooxidatively degrade carbon-containing deposits (so-called active coating).
With the aforementioned sol-gel coating method, the precursor materials are applied to the template body 2 made of the metal by means of conventional, in particular wet chemical methods such as e.g. spraying or immersion or flooding or rolling or painting. The coatings are then thermally cured, typically in a temperature range of between room temperature to about 300° C. Higher curing temperatures of e.g. more than 400° C. are generally less suitable because they often result in glass-like coatings with less adhesive effect. With thermally unstable side chains X, there is a risk of decomposition at high curing temperatures. For example, e.g. fluorine-containing side chains do not have sufficient thermal stability for high-temperature applications. In this case, curing temperatures and/or operating temperatures of 250° C. or higher result in the decomposition of the side chain and to a degradation of the hydrophobic effect of the coating. However, for low-temperature applications, such as can be advantageously provided in screen printing, fluorine-containing side chains X can further increase the water-repellent and oil-repellent effect. Short-chain side groups, such as e.g. X=methyl groups or aryl groups, on the other hand, demonstrate sufficient thermal stability up to the specified high-temperature range.
For oleophobic layer systems, for example, the resulting layer thickness d of the coating is advantageously in the region of less than 1 μm, while for scratchproof systems greater thicknesses d in the region of more than 5 μm are preferably chosen. Generally, resultant layer thicknesses d in the region of 1 to 5 μm are advantageous and also sufficient.

### II. Coatings Using a CVD Process

Non-stick coatings 6 according to the invention based on metal alkoxide can also be generated by plasma-assisted reactive CVD (chemical vapor deposition) processes. For this, it is possible in particular to use reactive silane compounds such as e.g. hexamethyldisiloxane (HMDSO). Fluorine components can be incorporated into the coating by the addition of suitable fluorosilane compounds.
The application is performed in a known way e.g. in a low-pressure CVD system. Coating of the metallic template body 2a serving as a substrate inside systems using atmospheric pressure plasmas is also possible. As with sol-gel coatings, here once again an effect stability, such as in particular a hydrophobic property of CVD coatings with fluorine-containing components, is provided due to the thermal instability of fluorine groups up to a maximum of 250° C. Consequently, fluorine-free silane compounds should preferably be used for high-temperature applications.

Test coatings 6 obtained according to processes described above were applied to known template bodies 2a. The coatings were applied with different technologies such as e.g. by immersion, spraying, rolling and cured at temperatures of less than 200° C. Hereby, the upper side of the template was covered with an easily removed film during application. With immersion methods, the film is slightly infiltrated which is tolerable. With spray or roll methods, less material is applied; this places less stress on the film. Advantageously, the surface on over which the solder is applied by a doctor knife is not contaminated or coated during these processes. In particular, the walls 7 of the clearances are not coated.

The non-stick effect was demonstrated by determining the contact angle. The effect is also stable after several cleaning steps with and without rinsing agents. Advantageously, the coating according to the invention also results in less surface roughness. Therefore the problem observed in the prior art of roughness of the side walls and the associated poor loosening behavior with regard to the pastes used no longer exists.

1. A printing template of an SMT process comprising in its metallic template body clearances corresponding to a predetermined printing structure, through which a printing material is to be applied to a plate that is to be joined onto the printing template from below, characterized in that the metallic template body (2a) is provided with a thin coating (6) of a metal-alkoxide coating material the surface energy of which is reduced by chemical bonding of at least one organic component.

2. The printing template as claimed in claim 1, characterized in that the metal-alkoxide coating material at least comprises at least one alkoxide of one or more of the elements aluminum (Al), silicon (Si), tantalum (Ta), titanium (Ti), zirconium, (Zr), hafnium (Hf) or yttrium (Y).

3. The printing template as claimed in claim 1 or 2, characterized in that the organic component of the metal-alkoxide coating material is formed by an alkyl group or an aryl group or a siloxane group.

4. The printing template as claimed in any one of the preceding claims, characterized in that a fluorine-containing component is bonded to the metal-alkoxide coating material.

5. The printing template as claimed in any one of the preceding claims, characterized by a surface energy of the coating (6) of less than 20 mN/m, preferably less than 15 mN/m.

6. The printing template as claimed in any one of the preceding claims, characterized in that the maximum expansion (a) of at least one of the clearances (3) is between 200 μm and 500 μm.

7. The printing template as claimed in any one of the preceding claims, characterized in that the thickness (d) of the coating (6) is less than 10 μm, preferably less than 5 μm.

8. The printing template as claimed in any one of the preceding claims, characterized in that the printing material to be applied is a paste-like solder material or adhesive material.

9. The printing template as claimed in any one of the preceding claims, characterized by a template body (2a) comprising a steel or nickel (Ni) or a nickel alloy.

10. A method for coating a printing template as claimed in any one of the preceding claims, characterized by a sol-gel process, in which a molding material of the coating material is applied by wet chemical means to the metallic template body (2a) and then thermally cured.

11. The method as claimed in claim 10, characterized in that the application of the molded material is performed by spraying or immersion or flooding or rolling or painting.

12. The method for coating a printing template as claimed in any one of claims 1 to 9, characterized by a CVD process with plasma assistance under low pressure or atmospheric pressure.
